(19) United States
(12) Patent Application Publication
(10) Pub. No.: US 2016/0195677 A1
(43) Pub. Date: Jul. 7, 2016

(54) DEVICE INCLUDING MIRRORS AND FILTERS TO OPERATE AS A MULTIPLEXER OR DE-MULTIPLEXER

(71) Applicant: HEWLETT PACKARD ENTERPRISE DEVELOPMENT LP, Houston, TX (US)

(72) Inventors: Georgios Panotopoulos, Palo Alto, CA (US); Paul Kessler Rosenberg, Palo Alto, CA (US); Michael Renne Ty Tan, Palo Alto, CA (US); Wayne Victor Sorin, Palo Alto, CA (US); Sagi Varghese Mathai, Palo Alto, CA (US)

(21) Appl. No.: 14/911,446

(22) PCT Filed: Aug. 21, 2013
(86) PCT No.: PCT/US13/55908

§ 371 Date: Feb. 10, 2016

(51) Int. Cl. G02B 6/293; G02B 6/42

(52) U.S. Cl. CPC G02B 6/29365; G02B 6/2938; G02B 6/4214; G02B 6/4228; G02B 6/425

(57) ABSTRACT

A device includes a first element and a second element. The first element includes a plurality of mirrors formed as concave features on the first element. The second element is to support a plurality of filters. The first element is coupleable to the second element to align the plurality of mirrors relative to the plurality of filters to operate as a multiplexer or de-multiplexer.

### BACKGROUND

Systems for optical communication connections may use a combination of relatively expensive assemblies, such as multi-fiber optical connectors, and glass optical zigzags/relay cavities. These zigzags/relay cavities may incorporate many glass refractive lenses that need to be precisely formed, increasing manufacturing, assembly, and maintenance costs.

### BRIEF DESCRIPTION OF THE DRAWINGS/FIGURES

FIG. 1 is a block diagram of a device illustrating a first element and a second element according to an example.

FIG. 2 is a block diagram of a device illustrating a first element and a second element according to an example.

FIG. 3 is a block diagram of a device illustrating a first element, a second element, a third element, and a substrate according to an example.

FIG. 4 is a sectional view of a device taken along line 4 of FIG. 10, illustrating a first element, a second element, and a third element according to an example.

FIG. 4A is a detail sectional view of the device of FIG. 4, illustrating a first element, a second element, a third element, and a substrate according to an example.

FIG. 5 is a sectional view of a device taken along line 5 of FIG. 10, illustrating a first element, a third element, and a substrate according to an example.

FIG. 5A is a detail sectional view of the device of FIG. 5, illustrating a first element, a fiber alignment element, an optical fiber, and a fiber clip according to an example.

FIG. 6 is a perspective view of a device illustrating a first element according to an example.

FIG. 6A is a detail perspective view of the device of FIG. 6, illustrating a plurality of mirrors and a plurality of fiber alignment elements according to an example.

FIG. 7 is an exploded perspective view of a device illustrating a first element, a second element, a plurality of optical fibers, a fiber boot, and a fiber clip according to an example.

FIG. 8 is a perspective view of a device illustrating a first element, a second element, a plurality of optical fibers, a fiber boot, and a fiber clip according to an example.

FIG. 9 is a perspective view of a device illustrating a first element, a second element, a third element, a plurality of sources/detectors, and a substrate according to an example.

FIG. 10 is a perspective view of a device illustrating a first element, a second element, a third element, a plurality of sources/detectors, and a substrate according to an example.

### DETAILED DESCRIPTION

Optical communication can involve transmitting information over optical fibers using light. Such fibers may use optical connectors to interface the optical fibers with communication systems. Wave division multiplexing (WDM) may be used to encode multiple optical data signals onto different wavelengths of light, and combine those data signals for transmission along a single optical fiber. The various optical signals may remain separate during transmission through the optical fiber. At their destination, the signals can be separated with spectral filters into the original unique data signals. Coarse WDM (CWDM) is a version of WDM where the wavelength spacing between optical channels is approximately 5 nanometers (nm) or greater. CWDM can be contrasted with dense WDM (DWDM), where channel-channel spacing is on the order of approximately 1 nm or less. The advantages of CWDM, compared to DWDM, include cost and space savings by using fewer optical fibers and connectors. CWDM also enables server and switch systems to have a low initial cost of ownership, while also offering significant bandwidth upgrade potential through the addition of data signals by using additional light wavelengths.

Example devices described herein may provide very low cost matable-dematable CWDM optical connectors having improved reliability and simplicity, for use in optical communication systems. In an example, a device may be provided based on low cost injection molding (e.g., plastic) for a WDM optical connector. The optical connector may include a first element that aligns/connects to other elements based on alignment elements.

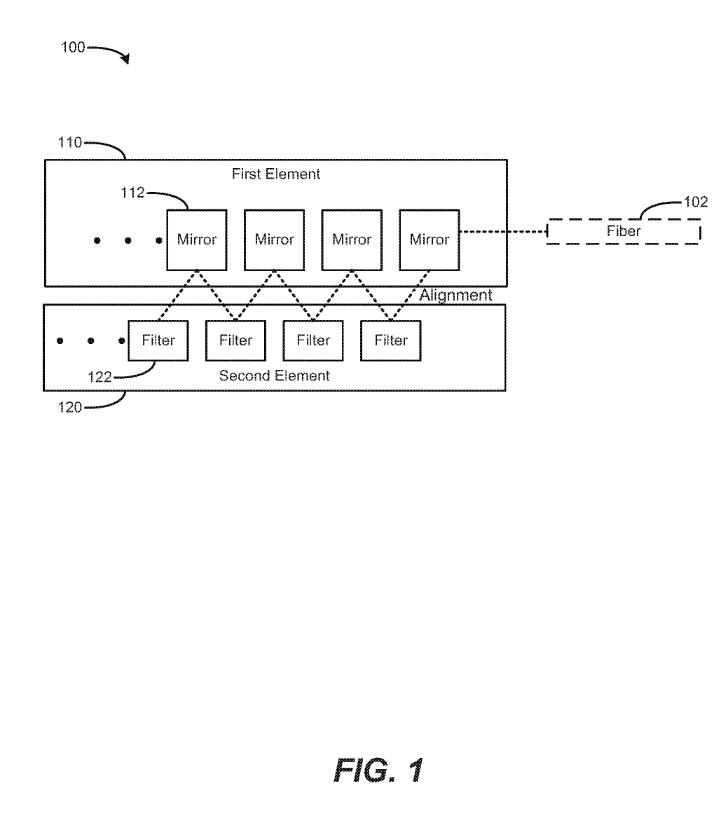

FIG. 1 is a block diagram of a device 100 illustrating a first element 110 and a second element 120 according to an example. The first element 110 is associated with a plurality of mirrors 112. The second element 120 is associated with a plurality of filters 122. The first element 110 is to be optically coupled with the optical fiber 102.

The first element 110 may include various precision features that may be precisely aligned relative to each other based on the fabrication of the first element 110, without a need to perform separate alignment steps for the individual components after fabrication of the first element 110. The mirrors 112 may be aligned in the first element 110 for use in conjunction with the second element 120 to produce a zigzag multiplexer/de-multiplexer optical element. The mirrors 112 may include a first type of mirror, e.g., a row of parabolic lenses to optically couple optical fibers 112 with the device 110, and a second type of mirror, e.g., relay lenses to provide functionality as an optical zigzag (e.g., relay cavity) element. The first element 110 may include additional alignment features, such as a fiber alignment element to align optical fibers relative to the mirrors 112, and alignment elements (e.g., mechanical standoffs) to provide alignment for positioning other components of the optical system (e.g., second element 120) relative to the first element 110.

The first element 110 is to provide the mirrors 112 with precision alignment for WDM. The first element 110 may be provided as a single part, and may be formed out of plastic based on injection molding, formed out of metal based on stamping, and formed by using other materials/techniques. The first element 110 may be created using a tool to transfer the precision details to the first element 110, e.g., a precision mold or stamp. Thus, the first element 110 may be formed to include various precision features that are set in alignment upon formation, that do not need to be implemented in separate parts that would have to be aligned and fixed relative to each other in the process of assembling the finished first element 110. In alternate examples, the mirrors 112 along with other components of first element 110 may be provided separately from the first element 110 for subsequent assembly. The first element 110 is also to provide alignment of the optical fiber 102. The first element 110 may include fiber alignment elements (e.g., based on the same fabrication step used to create the first element 110) to receive and orient the optical fiber 102 relative to the first element 110. Thus, the first element 110 may be efficiently produced, e.g., based on injection molding, to fabricate the entire first element 110, which may include the mirrors 112 and fiber alignment elements to receive the fiber 102. Furthermore, the first element 110 may include features to provide alignment for the second element 120, relative to the first element 110 and the various components of the first element 110. In an example, the first element 110 includes alignment elements and mechanical standoffs to precisely position the second element 120 and establish a desired distance between the mirrors 112 and filters 122 to enable proper functionality as a zigzag/relay cavity.

The second element 120 is to provide the filters 122 in alignment with the mirrors 112 of the first element, enabling the device 100 to function as a WDM zigzag/relay cavity. The second element 120 may be a glass slab coated with the optical filters, or other form of filter substrate to support the filters 122 in alignment. Thus, the device 100 my serve as a WDM platform incorporating a zigzag-style optical multiplexer/de-multiplexer. The alignment between the mirrors 112 and filters 122 provided by the first element 110 enables a collimated light beam to undergo a series of reflections (full and/or partial) along the inner faces of the zigzag between mirror(s) and filter(s), to combine and/or separate the various wavelengths. In an example, a device 100 may function as a de-multiplexer receiver, to separate different received wavelengths from the optical fiber 102, e.g., four different light wavelengths coupled into the device 100 from the optical fiber 102. These collimated beams reflect through the device 100 until they encounter a spectral filter 122 (a filter having an associated pass wavelength), at which point the corresponding passed wavelength may exit the zigzag at that filter, to be coupled into a detector (not shown in FIG. 1). Remaining wavelengths continue onward to be separately passed through corresponding filters of the second element 120. A similar technique may be used in reverse, based on light sources that emit light, to be combined/multiplexed together by the zigzag and coupled into the optical fiber 102.

Thus, device 100 enables high-precision elements to be consolidated into and aligned by the first element 110, thereby reducing the cost and complexity of other elements, as well as simplifying overall manufacturing and assembly. For example, the first element 110 may include the mirrors 112 and other precision-aligned components (fiber alignment elements, mechanical standoffs, etc.), in contrast to the second element 120 that may be provided as, e.g., a simple flat substrate. In an example, the second element 120 may be manufactured as a glass wafer without a need to include special lenses or other contours to provide refractive effects on the light. The filters 122 may be applied to that simple glass wafer using deposition, and the wafer may be diced to size to provide the second element 120 including the filters 122.

The mirrors 112 of the first element 110 may be formed based on concave mirror features of the first element 110, in contrast to convex features of the glass slab (such as lenses) that may be more difficult to manufacture, compared to concave features molded into the first element 110. Accordingly, the first element 110 may provide both light collimation and mode matching between the optical fiber 102 and the cavity, based on a reflective element (the mirrors), in contrast to using a refractive element such as a lens (e.g., a lens formed as a convex feature of the second element 120). In alternate examples, device 100 may make use of both reflective and refractive elements. Use of the mirrors 112 by the first element 110 provides benefits in terms of improved temperature stability and chromatic dispersion characteristics, compared to use of refractive elements. For example, relay mirrors can keep the optical beam collimated as it bounces in the relay cavity, and parabolic mirrors can couple the relay cavity to the optical fiber 102. The lenses formed as surfaces of the first element 110 (e.g., as a concave features of the first element 110), are more resistant to changes in performance characteristics as a function of temperature, e.g., as compared to lenses.

The filters 122 may be spectral filters, e.g., monolithic wavelength filters that may be attached to the second element 120. The filters 122 may selectively pass light of specific wavelengths, and reflect light of other wavelengths. In an example, the filters 122 may be grown as a glass wafer, diced, and glued to the second element 120. The filters 122 may be grown directly on the second element 120. The second element 120 and filters 122 are to have parallelism properties suitable for WDM, e.g., based on interactions with the first element 110.

The second element 120 may be oriented relative to the first element 110 and assembled based on passive alignment, without a need for additional semiconductor processing. The various components of device 100 are arranged such that alignment of the filters 122 relative to other components of the device 100 (e.g., to the first element 110 and associated mirrors 112 and/or optical fiber 102) may tolerate a level of precision on the order of approximately 25 or 50 microns. Thus, the first element 110 and the second element 120 may interact with each other based on physical alignment elements, to passively align the second element 120 relative to the first element 110. In an example, the second element 120 may be a filter substrate block that may be inserted into the first element 110 against physical stops (e.g., mechanical standoffs) of the first element 110, to passively and correctly align the second element 120 into the correct location relative to the first element 110.

The optical fiber 102 may be aligned to the first element 110 based on, e.g., molded recesses formed in the first element 110 of the connector device 100. The recesses may receive and position the optical fiber 102, which may include an array of multiple optical fibers. The first element 110 may include groves and stops to facilitate the positioning of the optical fibers 102. The optical fiber 102 may be positioned to enable optical coupling between at least one mode of the optical fiber 102 and the mirrors 112, e.g., to a parabolic mirror positioned to align with the optical fiber 102. Thus, the first element 110 may include features (e.g., guides, physical stops) that precisely align a tip of an optical fiber 102 at a specific distance/orientation from the parabolic mirror. In an example, the first element 110 may be formed of a material transparent to the desired wavelengths (e.g., transparent plastic), enabling the optical fibers 102 to be placed up against a molded stop of the first element 110, which may involve the use of some index-matching glue or other material. In an example of an opaque first element 110 (e.g., including where the first element 110 is formed of a reflective material to provide mirrors 112 therein), the optical fiber 102 may be loaded into and held stationary by the first element 110 to establish an appropriate Z-axis position/distance to the mirror 112.

The device 100 may be assembled by inserting the optical fibers 102 into the first element 110, and optionally gluing the optical fibers 102 into place in the first element 110. The second element 120 may be coupled to the first element 110. The assembled first element 110 may then be selectively attached and detached from an underlying substrate (not shown), without affecting alignment of the various components relative to each other. This enables the flexibility of soldering some portions of an optical assembly in place on a substrate before attaching the assembled first element 110, such that the first element 110 and associated optical fibers 102 and second element 120 do not get in the way of soldering. Attaching the assembled/aligned first element 110 to the substrate and associated components may be done based on passive alignment, without disturbing the precise alignment between the optical fibers 102, mirrors 112, and filters 122 in the assembled first element 110. Thus, the assembled device 100 enables an easy technique of “pig-tailing” components by adding connected optical fibers 102 to a component based on passive alignment.

The device 100 can perform as a multiplexer and/or as a de-multiplexer. For example, two devices 100 may be arranged to communicate with each other. The input device 100 may multiplex multiple wavelengths into a single fiber 102 on the input side, and the output device 100 may de-multiplex the multiple wavelengths from the single fiber 102 on the output side. The assembled first element 110, including the variously precision aligned components, may be snapped onto different underlying components to function as a multiplexer or de-multiplexer. For example, the underlying components may include a plurality of optical sources that emit light to the device 100 for multiplexing, and/or may include a plurality of optical detectors that detect light de-multiplexed from the device 100.

In an example device 100, wave division multiplexing (WDM) may be used on 48 optical channels, each operating at 25 Gbps, for use in an intra-chassis data communication application. Optical signals may be generated at four different wavelengths and combined onto a single fiber (e.g., using 12 single fibers to carry the 48 optical channels). Thus, device 100 enables simplification and cost reduction for optical interconnect fabrics.

Examples of device 100 may operate with any number of different wavelength sources/receivers, to be multiplexed/de-multiplexed based on wavelength. Thus, examples may accommodate data interconnection fabrics to be used in computer server and network switch chassis, to increase signal bandwidth and cable/connector density. Examples described herein may be used as WDM transmitter and receiver optoelectronic (OE) engines, with the flexibility of implementing optics based on silicon photonics (SiPh) or vertical-cavity surface-emitting laser (VCSEL) architectures, without having to commit to these or any other specific implementation. The device 100 may be ‘snapped onto’ various types of underlying optical systems that may be secured to a printed circuit board or other substrate. Accordingly, a WDM optical fabric based on examples of device 100 may be comprised of single-mode and/or multi-mode fibers and connectors, to interoperate with VCSEL and SiPh platforms, and others.

The device 100 supports CWDM, to offer a right-sized optical infrastructure at the beginning and end of a lifetime of a server or networked switch system. Unlike single-wavelength systems, infrastructures based on CWDM supported by device 100 can accommodate capacity increases over time. Thus, it is not necessary to decide up front whether to add additional fibers and connectors for additional capacity, or risk paying up front for excess, unneeded fiber capacity during the initial lifetime years of operation. Because of the ability to increase capacity easily over time, WDM architectures based on examples of device 100 can deliver the lowest possible system acquisition cost, while enabling servers and switches to achieve, e.g., an eight-fold bandwidth increase or more over the lifetime of the architecture.

Thus, the device 100 is able to combine the functionality of multiple components into a single element that precisely aligns the various components relative to each other, thereby lowering cost of individual elements and the cost to assemble those elements into the device 100. Reliability is also improved, because there are fewer optical interfaces to shift relative to each other, over time and temperature variations during the lifetime of the system.

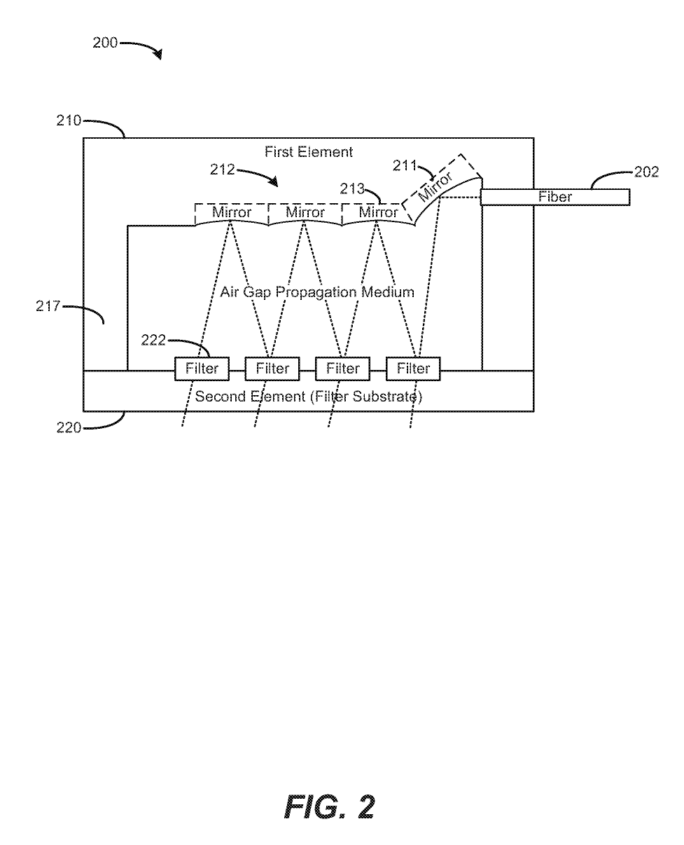

FIG. 2 is a block diagram of a device 200 illustrating a first element 210 and a second element 220 according to an example. The first element 210 is associated with a plurality of mirrors 212, including a parabolic mirror 211 and a relay mirror 213. The second element 220 is associated with a plurality of filters 222, and may be aligned relative to the first element 210 based on the mechanical standoffs 217 of the first element 210. The first element 210 is to be optically coupled with the optical fiber 202.

The first element 210 may provide spacing for the air gap propagation medium, e.g., based on the mechanical standoffs 217 that precisely and passively establish the spacing. The first element 210 may be formed of stamped metal, or injection molded plastic, or other suitable materials to establish the spacing. The mirrors 212 may be formed out of the material of the first element 210. For example, if the material is reflective, the mirrors 212 may be formed as concave features in the surface of the first element 210. In other non-reflective materials, such as some plastics, the mirrors 212 may be formed as concave features in the first element 210 that are to receive a reflective coating applied to the concave features. The mirrors 212 may include multiple types, such as relay mirrors 213 and parabolic mirrors 211. Thus, the mirrors 212 enable mode matching between the relay cavity of the device 200 and the optical fiber 202 based on the parabolic mirrors 211, while maintaining good collimation within the relay cavity based on the relay mirrors 213. The parabolic mirror 211 enables optical coupling to at least one mode supported by the optical fiber 202, which may support one or multiple modes.

The air gap propagation medium can serve as a relay cavity/zigzag, instead of needing a solid piece of glass or other substrate to allow the light to reflect back and forth. Using air as the propagation medium for the relay cavity provides benefits compared to using a solid element, in terms of improved chromatic dispersion and temperature stability. Furthermore, the first element 210 forming the air relay cavity can be made from opaque, and even reflective materials, (e.g. metal stamping, molded plastic), without needing to provide transparent qualities of a solid slab to form the relay cavity.

The second element 220 (filter substrate) is shown with the filters on the top surface of the second element 220. The filters may be attached to, or grown directly on, the filter substrate. The substrate may be transparent to the wavelengths used. As shown, each filter allows a portion of light to pass through that filter and the filter substrate 220. The light passing through may interact with underlying components onto which the device 200 is coupled.

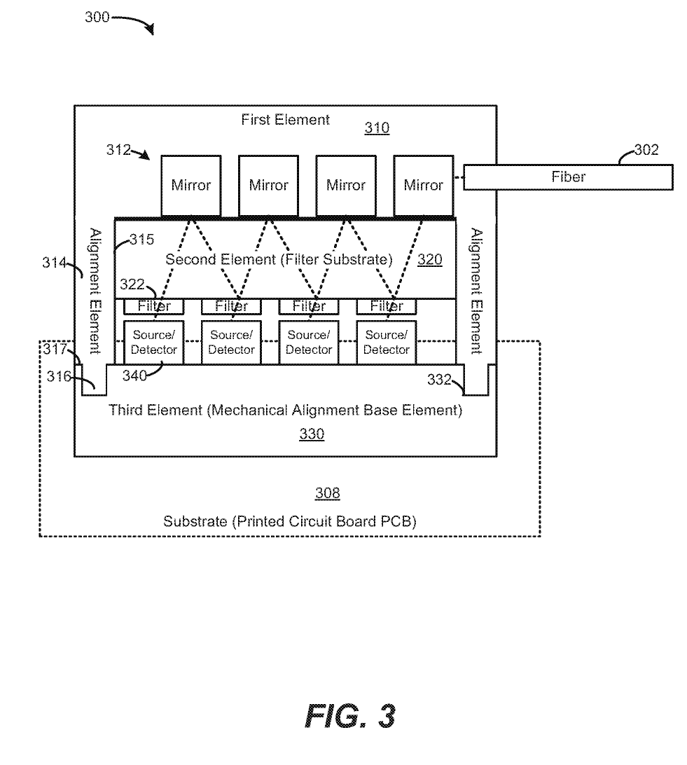

FIG. 3 is a block diagram of a device 300 illustrating a first element 310, a second element 320, a third element 330, and a substrate 308 according to an example. The first element 310 is associated with a plurality of mirrors 312. The second element 320 is associated with a plurality of filters 322. The third element 330 is coupled to the first element 310 via alignment elements 314. The alignment element 314 includes a physical stop 315, an engagement portion 316, and a mechanical standoff 317, to align various components. Substrate 308 is to support the third element 330 and the plurality of source/detectors 340. The first element 310 is to be optically coupled to the optical fiber 302.

The first element 310 may passively align the second element 320. For example, a top side of the second element 320 may touch the mirrors (e.g., may abut the portions of the first element 310 surrounding the mirror concavity), with the filters 322 positioned at a bottom side of the filter substrate 320. In an example, the second element 320 may be spaced from the mirrors 312, and coatings and/or index matching glue may be used to optically compensate for cavities between the mirror 312 and the second element 320. In addition to or as an alternative to the physical stops 315 along sides of the second element 320, the first element 310 may include other stops, e.g., to vertically position and passively align the second element 320 relative to the first element.

The third element 330 (e.g., a base) is to allow the first element 310 to passively assume the aligned position relative to the entire device 300, e.g., relative to the third element 330, source/detectors 340, and/or the substrate 308. The third element 330 may include alignment receivers 332 to receive the alignment elements 314 of the first element 310. In an example, two precision holes may be formed in the third element 330 to control the position of the first element 310.

Thus, the alignment elements 314 enable the first element 310 to repeatedly achieve very precise alignment with respect to the active optical elements (source/detectors 340, such as VCSELs, lasers, photodiodes, photodetectors, and so on) with which the first element 310 optically communicates. This alignment is facilitated by the interaction of the alignment element 314 with the third element 330. The alignment element 314 may be provided as alignment pins, to interact with holes fabricated in the third element 330. The alignment element 314 is shown formed in the first element 310, and the alignment receiver 332 is shown formed in the third element 330. However, in alternate examples, such pins and holes or other features can be distributed between the first element 310 and third element 330 as desired, e.g., by forming pins on the third element 330 and holes on the first element 310, or any of various combinations, as desired. The first element 310 may be secured to the third element 330 based on a friction fit, a snap-together assembly, or other techniques. In an example, the two pieces may be selectively locked together based on a pivoting bale latch (not shown in FIG. 3).

The third element 330 may be aligned to the array of source/detectors 340 using an active, passive, or vision-aided align process. Although shown as a combined source/detector 340, such components may be provided as single-function optical sources or optical detectors, and do not need to provide dual-functionality in all examples. The aligned third element 330 may be fixed in place against the substrate 308, which may be a printed circuit board (PCB). The third element 330 may be fixed to the substrate 308 using a snap together assembly or other techniques, including a rapid curing adhesive such as light cure adhesive. Thus, with the third element 330 secured in place, the first element 310 (and its various other elements attached thereto) may be removed and reattached to the third element repeatedly, each time reacquiring precise alignment (e.g., within 5 micrometers or less) relative to the source/detectors 340 by means of the precise alignment registration between the alignment element 314 and alignment receiver 332 of the first and third elements 310, 330.

Thus, systems based on device 300, such as WDM optical engines, do not need costly active optical alignment, and instead enable benefits such as wafer-scale, solder self-alignment of several hundred or more laser and photodiode arrays in a single process step, resulting in elimination of a significant part of the cost of a typical optical transceiver. Solder self-alignment of source/detector arrays may provide accuracy within approximately 2 micrometers. Example designs are sufficiently tolerant to allow placement error of the source/detectors 340 of up to approximately +/−6 micrometers, associated with less than approximately 1.0 decibel (dB) of optical loss. A finished optical engine based on examples herein may be surface-mount solder attached, thus reducing size and cost while improving signal integrity. For example, the substrate 308 may be formed with electrical vias to communicate signals from the source/detectors 340 to an underside of the substrate 308, where solder balls are arranged for surface mounting to other systems using solder reflow. The source/detectors 340 may be precisely self-aligning relative to the substrate 308, e.g., based on solder reflow to eliminate costly active optical alignment of the source/detectors 340 relative to the substrate 308 and/or third element 330. Solder reflow may be used to secure the device 300 to customer printed circuit boards (PCBs), eliminating large, expensive electrical connectors while enabling superior signal integrity. Additionally, examples provided herein enable wafer-scale fabrication and assembly of optical connector alignment mechanisms such as device 300, simplifying fabrication and assembly.

Elements such as the source/detectors 340 and/or the third element 330 may be assembled onto the substrate 308 based on pick-and-place assembly, due to the various alignment features described. Elements may be flip-attached onto a precision electrical substrate fabricated on glass. Use of precision solder self-alignment directly on the system organic PCB 308 can eliminate the need to fabricate electrical traces on the secondary glass substrate.

The source/detectors 340 may include receivers, amplifiers, pin detectors, photodetectors, VCSELs, and so on. The source/detectors 340 may be provided as a 4-wavelength (4λ)×12 channel array of VCSELs. The source/detectors 340 may be provided as separate CWDM bottom-emitting VCSELs with integrated lenses. The example of FIG. 3 is shown using four different wavelengths, e.g., 990 nm, 1015 nm, 1040 nm, and 1065 nm. The wavelengths may be multiplexed and/or de-multiplexed by the second element 320 operating as an optical zigzag based on the filters 320 and relay mirrors 312. The fourth source/detector 340 (furthest from the optical fiber 302) is shown receiving light through a filter, although that filter may be omitted without compromising the ability of device 300 to function. However, the filter may provide further isolation and selective passing of various light signals for that source/detector 340.

The number of wavelengths that may be multiplexed into a single optical fiber 302 can vary. Thus, examples of device 300 may include fewer or greater numbers of mirrors 312, filters 322, and source/detectors 340. Materials may be used that remain transparent to a range of wavelengths to be used, enabling the addition of as many wavelengths as is desired. Light sources 340 are to provide a broad range of wavelengths consistent with the number of desired wavelengths, such that the device 300 may add the number of reflections/mirrors and number of filters/wavelengths to support the light sources having a broad range of wavelengths. In terms of the geometrical/optical design of the device 300, the lateral dimension may be extended to accommodate the additional reflections. Although some optical losses are associated with each bounce, as many as eight bounces (e.g., 8×WDM) have been demonstrated to provide very acceptable optical losses within specified tolerances.

With coarse WDM, the wavelength spacing may be on the order of 25 nm, such that the laser sources are separated in terms of where the wavelengths differ. However, if coarse WDM is desired with a spacing of 5 nm, the filters 322 may be challenging to fabricate for isolating the narrow differences in wavelength with desirable optical loss performance and having sharp cutoff frequencies to pass one range of wavelengths and reflect other wavelengths, while still providing acceptable over-temperature variation performance. In an example, 25 nm spacing was chosen to provide desirable over-temperature variation, good control of providing the desired wavelengths during production of the sources, and other beneficial attributes. Thus, lensed VCSEL arrays operating at wavelengths of 990 nm, 1015 nm, 1040 nm, and 1065 nm were developed to include the channel separation of 25 nm. Channel separation is to provide a broad tolerance window for VCSEL and filter component operation over variations on temperature and manufacturing processes. However, other wavelength values, including other spacing values, may be used. The spectrum between 990 nm and 1065 nm was chosen to improve device reliability and high-speed performance, due to a higher differential gain in the strained Indium Gallium Arsenide (InGaAs) material systems. Other values may be used, e.g., to take advantage of other types of material systems. In an example, reliability improvements may be derived from incorporating an aluminum-free, strain-compensated, multi-quantum-well active region in the light source devices. In an example, the VCSEL GaAs epitaxial structure is optically transparent at wavelengths greater than approximately 900 nm. This enables such VCSEL designs to incorporate lithographically defined amorphous silicon high contrast grating (HCG) structures, fabricated directly onto the back surface of the VCSEL array used for the sources 340 in device 300. These HCG structures may collimate and tilt the emitted light for optimum coupling into the zigzag element. In alternate examples, the source/detectors 340 may be physically tilted for coupling into the zigzag, or include mirrors/lenses to accomplish optimum coupling.

In an example application, device 300 may be incorporated into a switch application-specific integrated circuit (ASIC) co-packaged with WDM optics, where the detectors 340 are coupled to both sides of the ASIC that has flip-chip photodiodes. The system may support 9.6 terabits per second (Tbps) total into and out of the package, based on a custom optical example device 300 using ×4 mutliplexing and de-multiplexing, where each connector device 300 would support 48 fibers (4 ribbons of 12 fibers), each fiber supporting 100 gigabits per second (Gbps). A first connector device 300 may be used for input, and a second for output, on each side of the ASIC, providing 4.8 Tbps in/out on each side for a total of 9.6 Tbps.

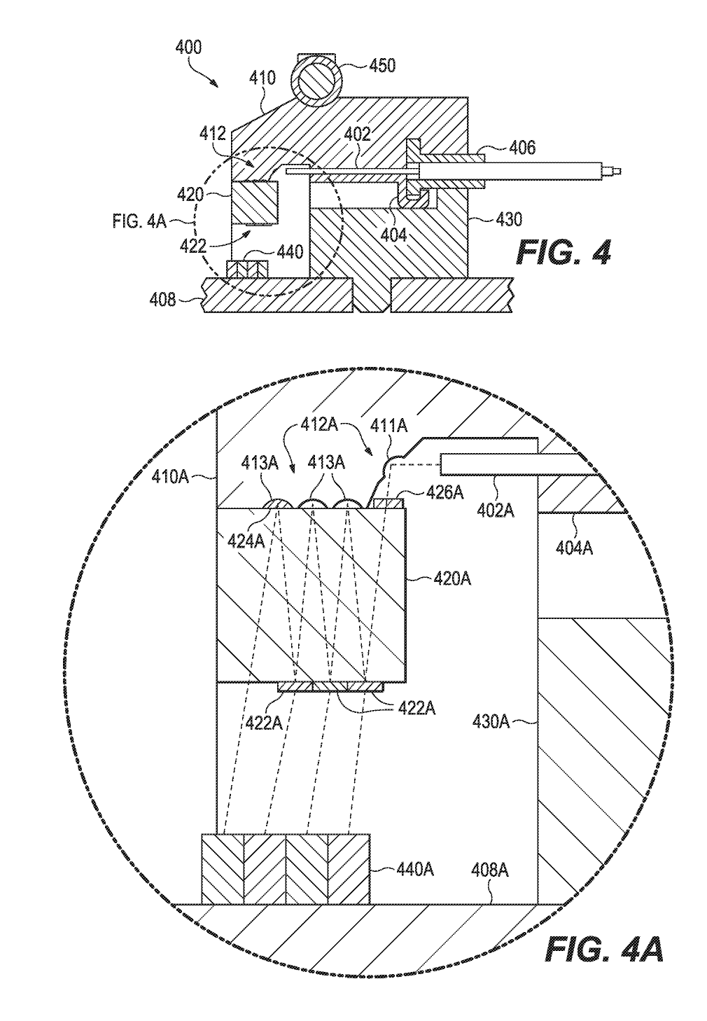

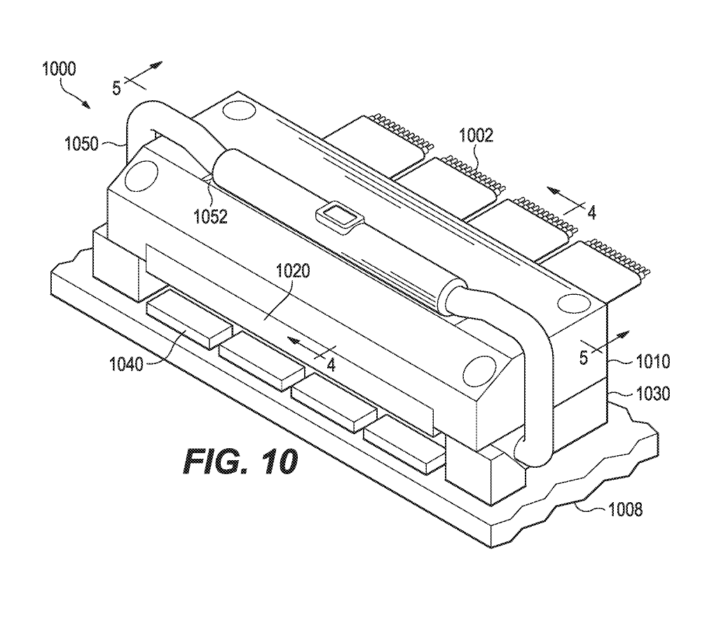

FIG. 4 is a sectional view of a device 400 taken along line 4 of FIG. 10, illustrating a first element 410, a second element 420, and a third element 430 according to an example. The first element 410 is to align various components relative to each other, such as the optical fiber 402, the mirrors 412, the second element 420, and the sources/detectors 440. The optical fiber 402 is coupled to the fiber boot 406 and fiber clip 404. The first element 410 is coupled to the second element 420 and third element 430. The second element 420 is to align the filters 422 relative to the mirrors 412 and the sources/detectors 440. Substrate 408 is to support the sources/detectors 440 and the third element 430. The sources/detectors 440 may be aligned relative to the first element 410 via the substrate 408 and third element 430 that is coupled to the first element 410. A bale 450 is shown in an engaged position, to secure the first element 410 to the third element 430.

The optical fiber 402 is shown extending toward the mirrors 412, and secured at an aligned distance for optical coupling to a mode supported by the optical fiber and the device 400. This alignment may be secured in position relative to the first element 410, and remain aligned regardless of whether the first element 410 is removed from and/or reconnected to the third element 430.

The fiber clip 404 includes a portion to partially wrap around and secure the fiber boot 406, to resist the fiber boot 406 from being pulled out of the first element 410.

The third element 430 is shown extending partially into the substrate 408, based on an alignment mechanism extending from the third element 430 into the substrate 408. Accordingly, the third element 430 may be passively aligned relative to the substrate 408. Similarly, the third element is passively aligned relative to the sources/detectors 440 positioned on the substrate 408 (e.g., based on reflow solder passive alignment). The sources/detectors 440 are spaced from the filters 422 and second element 420 based on an air gap.

FIG. 4A is a detail sectional view of the device 400 of FIG. 4, illustrating a first element 410A, a second element 420A, a third element 430A, and a substrate 408A according to an example. The first element 410A is to align the optical fiber 402A with the plurality of mirrors 412A, including a parabolic mirror 411A and a relay mirror 413A. The mirrors 412A are aligned with the filters 422A of the second element 420A, and the sources/detectors 440A that are coupled to the substrate 408A. A cavity formed by mirrors 412A may include an index-matching material 424A. A surface of the second element 420A may include a coating 426A. The first element 410A is coupled to the third element 430A, which is in turn coupled to the substrate 408A.

In the example of FIG. 4A, four sources/detectors 440A are used, corresponding to three filters 422A. Thus, the last source/detector 440A (furthest from the optical fiber 402A) is operable without the use of a filter 422A between that source/detector 440A and the second element 420A.

The parabolic mirror 411A is arranged for optically coupling with the optical fiber 402A, which may involve focusing the light to a desired mode(s) of the fiber. The relay mirrors 413A are arranged for maintaining collimation of the light to/from the filters 422A and source/detectors 440A.

The index matching material 424A, such as an index matching glue, may be included between various components, such as at spacing between the first element 410A and the second element 420A. The index matching material 424A is shown filling a concavity formed by a relay mirror 413A. In alternate examples, other concavities also may be fully and/or partially filled, and index matching material 424A also may be placed in other areas, including non-mirror cavity portions between the first element 410A and the second element 420A. The index matching material 424A is to improve uniformity in characteristics that may affect the transitions of light between the second element 420A and the mirrors 412A. For example, the index matching material 424A may minimize refraction by replacing air that would otherwise occupy the concavity, based on providing an index of refraction that is more similar to the second element 420A than air.

The coating 426A (e.g., an error coating) is shown on a surface of the second element 420A corresponding to where the light transitions between the second element 420A and an air cavity between the first element 410A and the second element 420A. In alternate examples, index matching glue/material also may be used in the air cavity, and the coating 426A may be omitted or used in conjunction with such index matching material. The coating 426A is to accommodate changes in refractive index between the second element 420A and other materials the light passes through, such as the air and/or other index matching materials between the second element 420A and the parabolic mirror 411A.

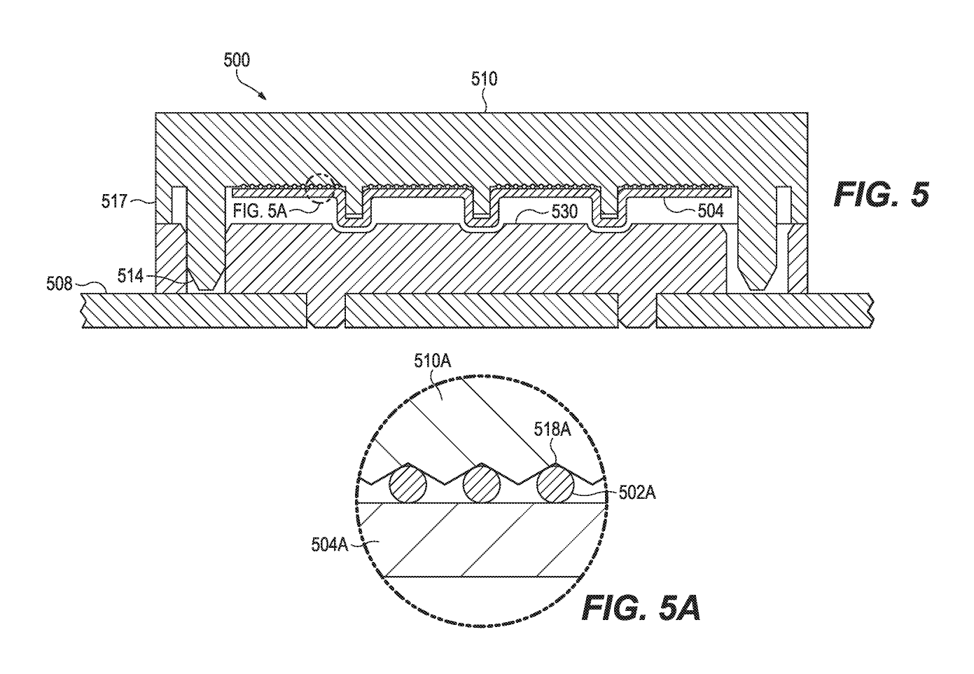

FIG. 5 is a sectional view of a device 500 taken along line 5 of FIG. 10, illustrating a first element 510, a third element 530, and a substrate 508 according to an example. The first element 510 includes an alignment element 514 and mechanical standoff 517, to couple with the third element 530. The fiber clip 504 is coupled to the first element 510.

The alignment element 514 is to establish lateral alignment of the first element 510 relative to the third element 530 (and other components). The alignment element 514 is shown extending toward and spaced from the substrate 508, to avoid affecting a height/distance alignment between the first element 510 and the third element 530. However, in alternate examples, the alignment element 514 may extend to contact the substrate 508 and provide a height/distance alignment. As illustrated, the mechanical standoff 517 is to provide the desired precision height/distance alignment between the first element 510 and the third element 530.

FIG. 5A is a detail sectional view of the device 500 of FIG. 5, illustrating a first element 510A, a fiber alignment element 518A, an optical fiber 502A, and a fiber clip 504A according to an example.

The fiber alignment element 518A is shown as a series of v-grooves to align the optical fibers 502A relative to the parabolic mirrors (not shown). The fiber alignment elements 518A may be provided as u-grooves or other shapes to provide a physical reference for positioning and/or gripping the fibers 502A. The fiber alignment elements 518A may be molded into and/or stamped into the first element 510A during fabrication of the first element 510A. Accordingly, the first element 510A may include the various precision passive alignment features for various components upon fabrication, reducing a need for further alignment steps during assembly and operation.

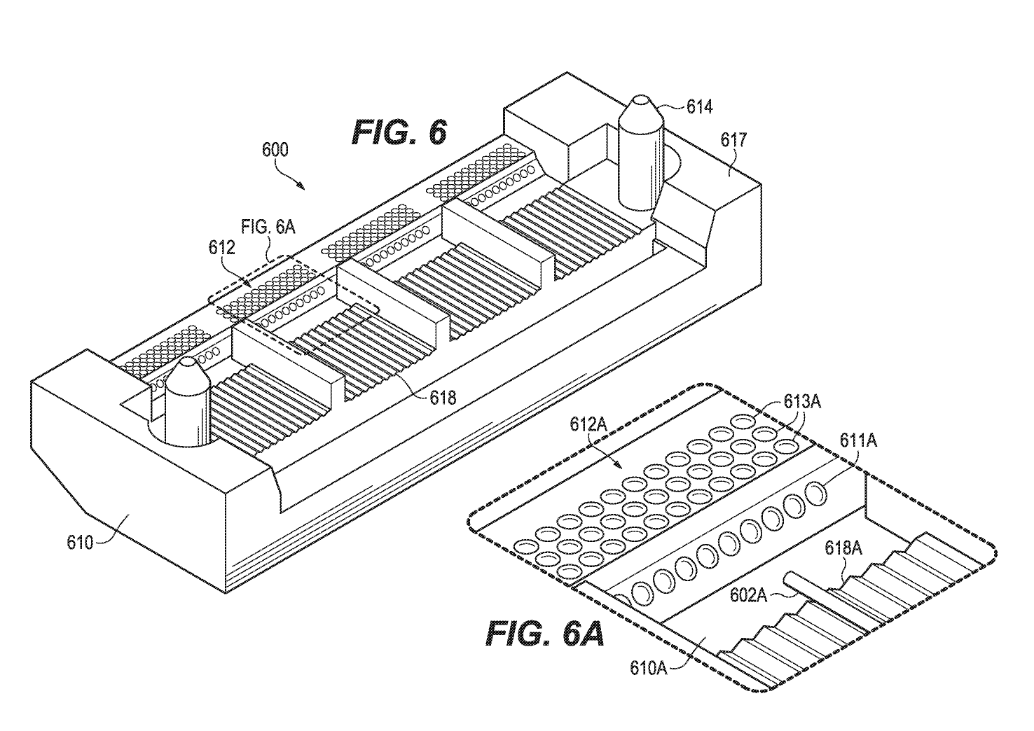

FIG. 6 is a perspective view of a device 600 illustrating a first element 610 according to an example. The first element 610 includes alignment element 614, mechanical standoff 617, and a plurality of mirrors 612 and fiber alignment elements 618. The first element 610 is shown inverted, to reveal the various details of its underside that would normally, when assembled, face downward toward second and third elements (not shown).

A total of 48 fiber alignment elements 618 are shown separated into four groups of twelve grooves. Each group may receive a bundle of fibers. In alternate examples, the fiber alignment elements may be distributed in other arrangements, e.g., without being separated into multiple groups. Each fiber alignment element 618 is aligned with a corresponding set of mirrors 612.

The alignment element 614 is shown as a pin including a tapered end, to facilitate passive alignment. The tip of the alignment element 614 is flattened, to avoid contacting the substrate (not shown) during assembly. The mechanical standoff 617 provides a large surface area, to contact a third element (not shown) and establish the proper distance for operation of the mirrors 612 as a zigzag.

FIG. 6A is a detail perspective view of the device 600 of FIG. 6, illustrating a plurality of mirrors 612A and a plurality of fiber alignment elements 618A according to an example. The plurality of mirrors 612A include a parabolic mirror 611A and a relay mirror 613A. A single optical fiber 602A is shown for reference, aligned by the fiber alignment element 618A of the first element 610A.

The parabolic mirrors 611A are shown at an angle relative to the optical fiber 602A, to optically couple the light relative to the second and third elements (not shown). In alternate examples, the mirrors 612A and/or the optical fiber 602A may be positioned at other angles for optical coupling and beam collimation.

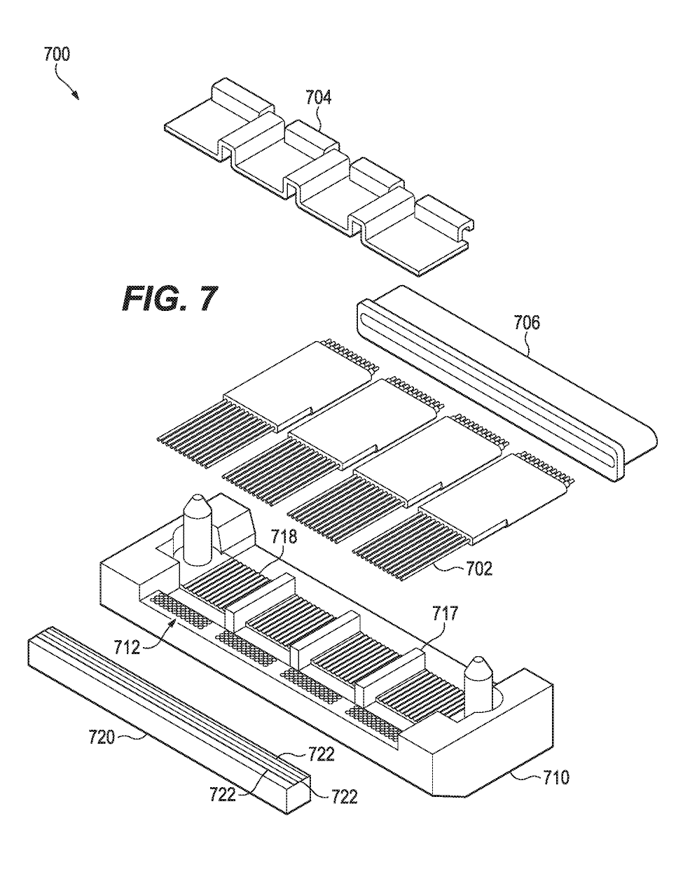

FIG. 7 is an exploded perspective view of a device 700 illustrating a first element 710, a second element 720, a plurality of optical fibers 702, a fiber boot 706, and a fiber clip 704 according to an example. The first element 710 includes a plurality of mirrors 712, fiber alignment elements 718, and mechanical standoffs 717. The second element 720 includes a plurality of filters 722.

The optical fibers 702 are shown as four 1×12 optical fiber arrays, providing 48 total fibers. The first element 710 includes walls to separate the fibers into the four groups. The walls include an end that is to serve as a mechanical standoff 717, to contact the second element 720 and ensure a lateral alignment of the filters 722 and second element 720 relative to the mirrors 712 and first element 710. Thus, the second element 720 may be assembled with and passively aligned relative to the first element 710, facilitating straightforward assembly based on precise mechanical features of the first element 710 (e.g., mechanical standoff 717). Such mechanical features of the first element 710 may be formed initially (e.g., during molding/stamping of the first element 710), and also may be formed/revised in subsequent stages. For example, a machining process may be used to adjust dimensions of a surface of the first element 710, to alter the alignment properties of that surface and change a relative positioning between various components.

The fiber boot 706 is a strain relief boot, to help secure the optical fibers 702 to the first element 710. The fiber boot 706 includes a lip for the first element 710 and fiber clip 704 to grip, to help secure and align the optical fibers 702. Additionally, glue or other fixing agents may be used.

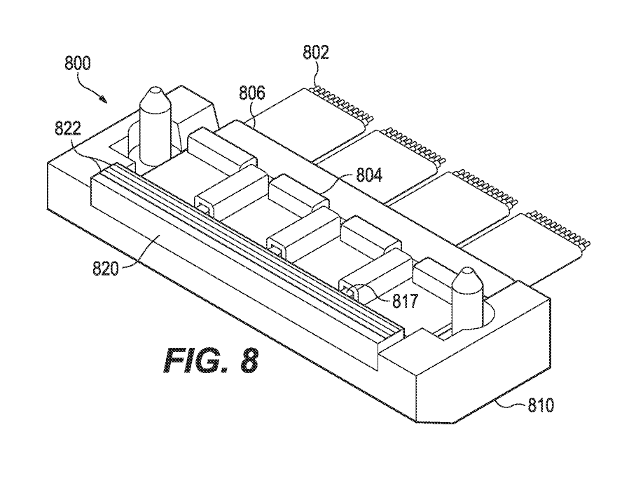

FIG. 8 is a perspective view of a device 800 illustrating a first element 810, a second element 820, a plurality of optical fibers 802, a fiber boot 806, and a fiber clip 804 according to an example. The second element 820 includes a plurality of filters 822, and is positioned relative to the mechanical standoff 817 of the first element 810.

The device 800 is an assembled first element 810, with optical fibers 802 attached and aligned, and the second element 820/filters 822 attached and aligned (e.g., abutting the mechanical standoffs 817 for lateral alignment, and the mirror surface of the first element 810 for vertical alignment). Accordingly, the assembled first element 810 is ready to be mated to a corresponding third element (not shown), e.g., that is attached to a substrate. The assembled first element 810 may be repeatedly attached and removed, without disturbing the relative alignments of the optical fibers 802, mirrors (not shown), second element 820, and filters 822.

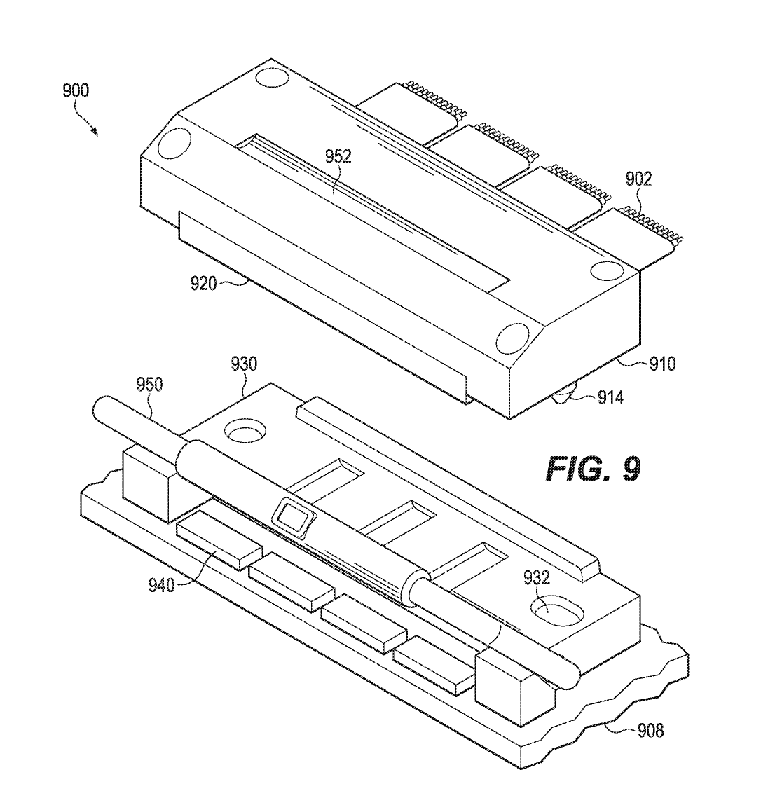

FIG. 9 is a perspective view of a device 900 illustrating a first element 910, a second element 920, a third element 930, a plurality of sources/detectors 940, and a substrate 908 according to an example. The first element 910 is to receive the optical fibers 902, and includes an alignment element 914 and bale receiver 952 for coupling to the third element 930. The third element 930 includes an alignment receiver 932 to receive the alignment element 914 of the first element 910. Bale 950 is pivotably coupled to the third element 930, and is shown in a disengaged position to enable the first element 910 to be received at the third element 930.

The first element 910 is shown assembled with its various components (e.g., second element 920, optical fibers 902, etc.), ready to be lowered to engage the third element 930. The bale 950 is rotated out of the way to allow the assembled first element 910 to be lowered into place. When in place, the bale 950 may be rotated over a top of the first element 910, to snap into the indentation of the bale receiver 952, to lock the first element 910 into place atop the third element 930.

The alignment receiver 932 may be provided as a hole, slot, or other shape corresponding to an alignment element 914 from the first element 910. The alignment element 914 and alignment receiver 932 may be interchangeable, and other arrangements may be used besides those specifically shown, to provide a high precision fit suitable for optical connectors. One of the alignment receivers 932 is shown as a round hole, and the other alignment receiver 932 is shown as a rounded slot, to enable more flexibility for insertion and positioning of the alignment elements 914 of the first element 910. In an example, the first element 910 and the third element 930 may be provided as different materials having different thermal coefficients of expansion, such that the rounded slot alignment receiver 932 allows for relative changes in distance between the two alignment elements 914 during temperature changes, ensuring that the first element 910 is not distorted over a range of temperatures.

FIG. 10 is a perspective view of a device 1000 illustrating a first element 1010, a second element 1020, a third element 1030, a plurality of sources/detectors 1040, and a substrate 1008 according to an example. Optical fibers 1002 are coupled to the device 1000. The bale 1050 is pivotably coupled to the third element 1030, and is shown in an engaged position resting in the bale receiver 1052 of the first element 1010, to secure the first element 1010 to the third element 1030.

FIG. 10 includes line 4 and line 5, corresponding to the section views of FIG. 4 and FIG. 5, respectively. The source/detectors 1040 are shown separate from the third element 1030, having been aligned relative to the third element 1030 by virtue of the substrate 1008. For example, the third element 1030 may be aligned based on alignment receiver holes in the substrate 1008 to receive alignment elements extending from the third element 1030 through the substrate 1008. The sources/detectors 1040 may be aligned based on solder reflow bumps/pads on the source/detectors 1040 and substrate 1008. In an alternate example, the third element 1030 may include features to provide mechanical standoffs for physically aligning the source/detectors 1040 relative to the third element 1030.

What is claimed is:

1. A device comprising:
a first element including a plurality of mirrors formed as concave features on the first element; and
a second element to support a plurality of filters;
wherein the first element is coupleable to the second element to align the plurality of mirrors relative to the plurality of filters to operate as a multiplexer or de-multiplexer.

2. The device of claim 1, further comprising a third element coupleable to the first element to passively align the second element with at least one of a plurality of light sources to enable operation as a multiplexer, and a plurality of photodetectors to enable operation as a de-multiplexer.

3. The device of claim 1, wherein the first element includes an alignment element to enable the first element to passively align relative to other components.

4. The device of claim 3, wherein the alignment element includes a physical stop to support and passively align the second element.

5. The device of claim 1, wherein the plurality of mirrors are multilayer dielectric mirrors.

6. The device of claim 1, wherein the plurality of mirrors and the plurality of filters are to provide wavelength division multiplexing (WDM).

7. The device of claim 1, wherein the second element is a filter substrate to support the filters and enable light to pass through the filter substrate.

8. The device of 1, wherein the first element comprises a metal or metalized plastic associated with a reflectivity to enable the plurality of mirrors to be formed as part of a surface of the first element.

9. The device of claim 1, further comprising an air gap between the first element and the second element to provide an air gap propagation medium for operation as a multiplexer or de-multiplexer.

10. The device of claim 9, wherein the first element includes mechanical stand-offs to establish a thickness of the air gap.

11. The device of claim 1, wherein the first element includes a fiber alignment element to secure and passively align an optical fiber in alignment with at least one mirror of the plurality of mirrors.

12. The device of claim 1, wherein the plurality of mirrors includes a relay mirror to collimate the light, and a parabolic mirror to optically couple the light with an optical fiber.

13. A device comprising:
a first element including a plurality of mirrors formed as concave features on the first element; and
a second element to support a plurality of filters;
wherein the first element is to reflect light according to the plurality of mirrors, to collimate and mode match the light based on reflections to operate as a multiplexer or de-multiplexer.

14. The device of claim 13, further comprising an optical cavity associated with operation as the multiplexer or de-multiplexer, wherein the plurality of mirrors are to enable optical coupling of the light between the device and an optical fiber to provide mode matching with a mode supported by the optical fiber.

15. A device comprising:
a first element including a plurality of mirrors formed on the first element; and
a second element to support a plurality of filters, wherein the second element is separated from the first element by an air gap to provide an air gap propagation medium;
wherein the first element is coupleable to the second element to align the plurality of mirrors relative to the plurality of filters separated by the air gap to operate as a multiplexer or de-multiplexer.
